(19) United States
(12) Patent Application Publication
(10) Pub. No.: US 2024/0346755 A1
(43) Pub. Date: Oct. 17, 2024

(54) INTERACTION PROCESSING METHOD AND APPARATUS FOR VIRTUAL SCENE, ELECTRONIC DEVICE, AND STORAGE MEDIUM

(71) Applicant: Tencent Technology (Shenzhen) Company Limited, Shenzhen (CN)

(72) Inventors: Ya ZHANG, Shenzhen (CN); Yiqi LI, Shenzhen (CN); Luyu SUN, Shenzhen (CN); Yinchao CHEN, Shenzhen (CN); Han WEN, Shenzhen (CN); Lijin WANG, Shenzhen (CN); Huizhong ZHANG, Shenzhen (CN)

(73) Assignee: Tencent Technology (Shenzhen) Company Limited, Shenzhen (CN)

(21) Appl. No.: 18/751,157

(22) Filed: Jun. 21, 2024

Related U.S. Application Data
(63) Continuation of application No. PCT/CN2023/110376, filed on Jul. 31, 2023.

(30) Foreign Application Priority Data
Sep. 5, 2022 (CN) 202211078598.7

(51) Int. Cl. G06T 17/00; G06T 13/40

(52) U.S. Cl. CPC G06T 17/00; G06T 13/40

(57) ABSTRACT

In an interaction processing method a virtual scene in an interaction interface is displayed. The virtual scene includes multiple groups, and each of the groups includes at least one virtual object. Based on an advance control operation on a first group, the first group advancing in the virtual scene is displayed. A first prompt information of a first region is displayed based on the first group advancing to a first location and a distance between the first location and the first region in the virtual scene being less than a distance threshold. The first prompt information indicates that a first interaction event between the multiple groups has occurred in the first region.

### RELATED APPLICATIONS

The present application is a continuation of International Application No. PCT/CN2023/110376, filed on Jul. 31, 2023, which claims priority to Chinese Patent Application No. 202211078598.7, filed on Sep. 5, 2022. The entire disclosures of the prior applications are hereby incorporated by reference.

### FIELD OF THE TECHNOLOGY

This disclosure relates to the field of human-computer interaction technologies, including to an interaction processing method and apparatus for a virtual scene, an electronic device, and a storage medium.

### BACKGROUND OF THE DISCLOSURE

Human-computer interaction technologies for virtual scenes based on graphics processing hardware can implement, according to actual application requirements, diversified interactions between virtual objects controlled by users or artificial intelligence, and have broad practical values. For example, in virtual scenes such as games, real battle processes between virtual objects can be simulated.

However, information push methods provided by related technologies are usually used in shopping scenes or news information browsing scenes. Related technologies have no effective solutions to the problem of how to push information in game scenes to enrich interaction methods of games.

### SUMMARY

This disclosure provides an interaction processing method and apparatus for a virtual scene, an electronic device, a computer-readable storage medium, and a computer program product, which can accurately recommend information in a virtual scene, thereby enriching interaction methods of the virtual scene and improving user experience.

Examples of technical solutions in the present disclosure are implemented as follows:

An aspect of this disclosure provides an interaction processing method for a virtual scene. The method is performed by an electronic device, for example. In the method, a virtual scene is displayed in an interaction interface. The virtual scene includes multiple groups, and each of the groups includes at least one virtual object. Based on an advance control operation on a first group, the first group advancing in the virtual scene is displayed. A first prompt information of a first region is displayed based on the first camp group advancing to a first location and a distance between the first location and the first region in the virtual scene being less than a distance threshold. The first prompt information indicates that a first interaction event between the multiple camps groups has occurred in the first region.

An aspect of this disclosure provides an interaction processing apparatus for a virtual scene. The apparatus includes processing circuitry configured to display a virtual scene in an interaction interface. The virtual scene includes multiple groups, and each of the groups includes at least one virtual object. The processing circuitry is configured to display the first group advancing in the virtual scene based on an advance control operation on a first group. The processing circuitry is configured to display first prompt information of a first region based on the first group advancing to a first location and a distance between the first location and the first region in the virtual scene being less than a distance threshold. The first prompt information represents that a first interaction event between the multiple groups has occurred in the first region.

An aspect of the present disclosure provides an electronic device, which includes a memory, configured to store executable instructions; and a processor, configured to execute the executable instructions stored in the memory, to perform the interaction processing method for a virtual scene according to the aspects of this application.

An aspect of this disclosure provides a non-transitory computer-readable storage medium, storing computer executable instructions, the computer executable instructions being executed by the processor to perform the interaction processing method for a virtual scene according to the aspects of this application.

An aspect of this disclosure provides a computer program product, including a computer program or computer executable instructions, the computer program or the computer executable instructions being executed by a processor to perform the interaction processing method for a virtual scene according to the aspects of this application.

The aspects of this disclosure can have the following beneficial effects:

When the first group advances to a location near a region (for example, the first region) in which an interaction event has occurred in the virtual scene, the first prompt information of the first region is displayed in the human-computer interaction interface. On the one hand, a user can view, in a timely manner, the interaction event that has occurred in the virtual scene. On the other hand, by pushing prompt information of the interaction event bound to the region, interaction methods of the virtual scene are enriched.

### BRIEF DESCRIPTION OF THE DRAWINGS

FIG. 1A is a schematic diagram of an application mode of an interaction processing method for a virtual scene according to an aspect of this disclosure.

FIG. 1B is a schematic diagram of an application mode of an interaction processing method for a virtual scene according to an aspect of this disclosure.

FIG. 2 is a schematic structural diagram of an electronic device 500 according to an aspect of this disclosure.

FIG. 3 is a schematic flowchart of an interaction processing method for a virtual scene according to an aspect of this disclosure.

FIG. 4A-4D are schematic diagrams of an interaction processing method for a virtual scene according to aspects of this disclosure.

FIG. 5A and FIG. 5B are schematic flowcharts of an interaction processing method for a virtual scene according to aspects of this disclosure.

FIG. 6A and FIG. 6B are schematic flowcharts of an interaction processing method for a virtual scene according to aspects of this disclosure.

FIG. 7 is a schematic flowchart of an interaction processing method for a virtual scene according to an aspect of this disclosure.

FIG. 8 is a schematic flowchart of an interaction processing method for a virtual scene according to an aspect of this disclosure; and

FIG. 9 is a schematic flowchart of an interaction processing method for a virtual scene according to an aspect of this disclosure.

### DETAILED DESCRIPTION

To make the objectives, technical solutions, and advantages of this disclosure clearer, the following describes aspects in further detail with reference to the accompanying drawings. The described aspects are not to be considered as a limitation to this disclosure. All other aspects obtained by a person of ordinary skill in the art shall fall within the protection scope of this disclosure.

In the following description, the term “first/second/ . . . ” is only used to distinguish similar objects and does not represent a specific sequence of objects. “First/second/ . . . ” can be interchanged if allowed, so that the present disclosure described herein can be implemented in a sequence other than that illustrated or described herein.

Unless otherwise defined, meanings of all technical and scientific terms used in this specification are the same as those usually understood by a person skilled in the art to which this application belongs. The terms used herein are only for the purpose of describing are not intended to limit the present disclosure.

Before the present disclosure is further described in detail, a description is made on examples of nouns and terms in the present disclosure, and the nouns and terms in the present disclosure are applicable to the following explanations. The descriptions of the terms are provided as examples only and are not intended to limit the scope of the disclosure.

(1) In response to: used to indicate a condition or a state on which an operation to be executed depends. When the condition or state on which an operation to be executed depends is satisfied, one or more operations to be executed may be performed in real time or with a specified delay. Unless otherwise specified, there is no restriction on the sequence in which multiple operations to be executed are performed.

(2) Virtual scene: a scene displayed (or provided) by an application when running on a terminal device. The virtual scene can be a simulation environment of the real world, a semi-simulation and semi-fictitious virtual environment, or a purely fictitious virtual environment. The virtual scene may be any one of a two-dimensional virtual scene, a 2.5-dimensional virtual scene, or a three-dimensional virtual scene. The present disclosure do not limit the dimension of the virtual scene. For example, the virtual scene can include sky, land, and ocean. The land can include environmental elements such as deserts and cities, and a user can control a virtual object to move in the virtual scene.

(3) Virtual object: characters of various persons and objects that can interact in a virtual scene, or movable objects in a virtual scene. The movable object may be a virtual person, a virtual animal, an animation person, or the like, such as a person or an animal displayed in a virtual scene. The virtual object may be a virtual character representing a user in the virtual scene. The virtual scene may include multiple virtual objects, and each virtual object has a shape and a volume in the virtual scene, and occupies some space in the virtual scene.

(4) Client: Applications running in terminal devices to provide various services, such as video playing clients and game clients.

(5) Scene data: Characteristic data representing a virtual scene, which may be, for example, an area of a construction region in the virtual scene and a current architectural style of the virtual scene, and may also include a location of a virtual architecture in the virtual scene and a floor area of the virtual architecture.

The present disclosure provides an interaction processing method and apparatus for a virtual scene, an electronic device, a computer-readable storage medium, and a computer program product, which can accurately recommend information in a virtual scene, thereby enriching interaction methods of the virtual scene and improving user experience. The virtual scene in the interaction processing method for a virtual scene provided by this disclosure can be outputted completely based on a terminal device, or based on the collaboration of a terminal device and a server.

For example, the virtual scene can be an environment for virtual objects (such as game characters) to interact, for example, can be used for a game character to battle. By controlling an action of the game character, two parties can interact in the virtual scene, thus enabling users to relieve life stress during the game.

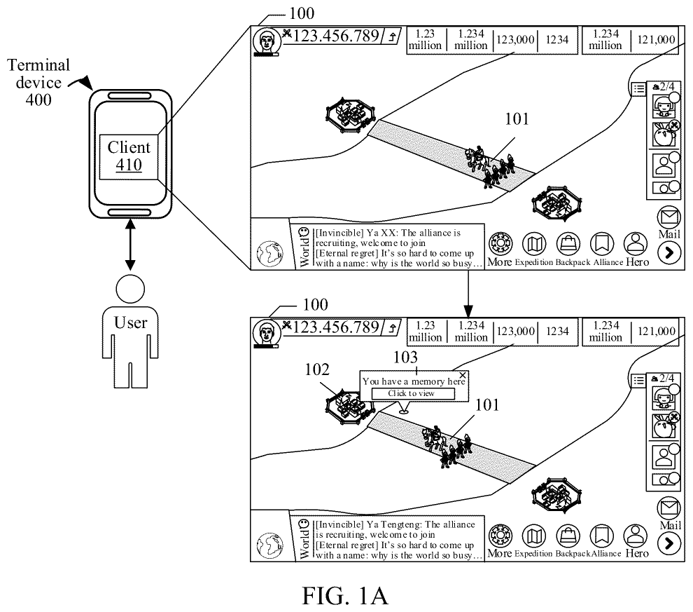

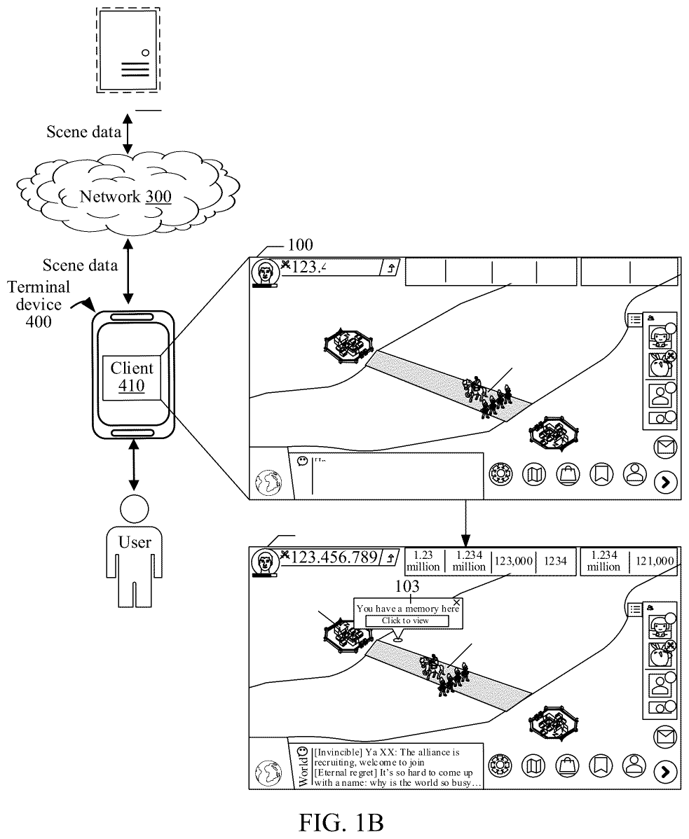

For example, refer to FIG. 1A. FIG. 1A is a schematic diagram of an application mode of an interaction processing method for a virtual scene according to an embodiment of the present application. The method is suitable for some application modes in which related data of a virtual scene 100 can be calculated completely based on computing power of graphics processing hardware of a terminal device 400, such as stand-alone/offline-mode games. The virtual scene can be outputted through various different types of terminal devices 400 such as smartphones, tablets, and virtual reality/augmented reality devices.

For example, a type of the graphics processing hardware includes a central processing unit (CPU) and a graphics processing unit (GPU).

When forming visual perception of the virtual scene 100, the terminal device 400 calculates, through the graphics computing hardware, data required for display, completes loading, parsing, and rendering of the display data, and outputs, through graphics output hardware, video frames capable of forming visual perception of the virtual scene, for example, presents two-dimensional video frames on a display screen of a smartphone, or projects video frames on lenses of augmented reality/virtual reality glasses to achieve a three-dimensional display effect. In addition, to enrich the perception effect, the terminal device 400 can also use different hardware to form one or more of auditory perception, tactile perception, motion perception, and taste perception.

As an example, the terminal device 400 runs a client 410 (for example, a stand-alone game application). During the running process of the client 410, a virtual scene including role-playing is outputted. The virtual scene may be an environment for game characters to interact, for example, can be plains, streets, and valleys for game characters to battle. For example, the virtual scene 100 is displayed from the third-person perspective. A first camp 101 (for example a first group, such as a group of virtual characters) is displayed in the virtual scene 100. Multiple virtual objects included in the first camp 101 are controlled by a current user and move in the virtual scene 100 in response to an operation performed by the current user on a controller (such as a touch screen, a voice-activated switch, a keyboard, a mouse, or a joystick). For example, when the user moves the joystick to the right, the multiple virtual objects included in the first camp 101 move to the right in the virtual scene 100 or can stay still or jump, or the multiple virtual objects included in the first camp 101 are controlled to perform shooting operations.

For example, in response to an advance control operation triggered by the user on the first camp 101, the client 410 displays that the multiple virtual objects included in the first camp 101 advance in the virtual scene 100. Then, in response to the first camp 101 advancing to the first location whose distance from the first region 102 in the virtual scene 100 being less than the distance threshold, the client 410 displays the first prompt information 103 of the first region (that is, when detecting that the distance between the first camp 101 and the first region 102 is less than the distance threshold, the client 410 displays the first prompt information 103 in the human-computer interaction interface), such as “you have a memory here”, thereby enriching interaction methods of the virtual scene and improving game experience of the user.

In another example, refer to FIG. 1B. FIG. 1B is a schematic diagram of an application mode of an interaction processing method for a virtual scene according to an embodiment of the present application. The method is applied to the terminal device 400 and the server 200 and is suitable for an application mode in which the computing power of the server 200 performs virtual scene calculation and the terminal device 400 outputs the virtual scene.

Taking formation of visual perception of the virtual scene 100 as an example, the server 200 calculates related display data (such as scene data) of the virtual scene and sends the data to the terminal device 400 through a network 300. The terminal device 400 completes loading, parsing, and rendering of the calculated display data through graphics computing hardware, and outputs the virtual scene through graphics output hardware to form visual perception, for example, may present two-dimensional video frames on the display screen of a smartphone, or project video frames on lenses of augmented reality/virtual reality glasses to achieve a three-dimensional display effect. For the perception of the form of the virtual scene, corresponding hardware output of the terminal device 400 can be used, for example, a microphone is used to form auditory perception, or a vibrator is used to form tactile perception.

As an example, the terminal device 400 runs a client 410 (for example, a network game application), and interacts with other users by connecting to a server 200 (for example, a game server). The terminal device 400 outputs the virtual scene 100 of the client 410. For example, the virtual scene 100 is displayed from the third-person perspective. A first camp 101 is displayed in the virtual scene 100. Multiple virtual objects included in the first camp 101 are controlled by a current user and move in the virtual scene 100 in response to an operation performed by the current user on a controller (such as a touch screen, a voice-activated switch, a keyboard, a mouse, or a joystick). For example, when the user moves the joystick to the right, the multiple virtual objects included in the first camp 101 move to the right in the virtual scene 100 or can stay still or jump, or the multiple virtual objects included in the first camp 101 are controlled to perform shooting operations.

For example, in response to an advance control operation triggered by the user on the first camp 101, the client 410 displays that the multiple virtual objects included in the first camp 101 advance in the virtual scene 100. Then, in response to the first camp 101 advancing to the first location whose distance from the first region 102 in the virtual scene 100 being less than the distance threshold, the client 410 displays the first prompt information 103 of the first region (that is, when detecting that the distance between the first camp 101 and the first region 102 is less than the distance threshold, the client 410 displays the first prompt information 103 in the human-computer interaction interface), such as “you have a memory here”, thereby enriching interaction methods of the virtual scene and improving game experience of the user.

For example, the terminal device 400 can also implement, by running a computer program, the interaction processing method for a virtual scene provided by the embodiments of the present application. For example, the computer program can be a native program or software module in an operating system, can be a native application (APP), that is, a program that needs to be installed in the operating system to run, such as a strategy game APP (that is, the client 410), can be a mini program, that is, a program that only needs to be downloaded to a browser environment to run; or can be a game mini application that can be embedded in any APP. In conclusion, the computer program can be any form of application, module, or plug-in.

Taking a computer program as an application as an example, during actual implementation, the terminal device 400 installs and runs an application that supports virtual scenes. The application can be any one of a first-person shooting game (FPS), a third-person shooting game, a virtual reality application, a three-dimensional map program, a strategy game (SLG), or a multiplayer gun battle survival game. A user uses the terminal device 400 to operate a virtual object in the virtual scene to perform activities. The activities include but are not limited to: at least one of adjusting the body posture, crawling, walking, running, riding, jumping, driving, picking up, shooting, attacking, throwing, and building a virtual architecture. Illustratively, the virtual object may be a virtual character, such as a simulated character or an animation character.

For example, aspects of the present disclosure can also be implemented with the help of a cloud technology. The cloud technology refers to a hosting technology that combines a series of resources such as hardware, software, and networks in a wide area network or a local area network to perform data calculation, storage, processing, and sharing.

The cloud technology is a general term for a network technology, an information technology, an integration technology, a management platform technology, an application technology, and the like applied based on the business mode of cloud computing, and may form a resource pool used on demand flexibly and conveniently. The cloud computing technology will become an important support. The background services of technical network systems require a large amount of computing and storage resources.

For example, the server 200 in FIG. 1B can be an independent physical server, or a server cluster composed of multiple physical servers or a distributed system, or can be a cloud server that provides basic cloud computing services such as cloud services, cloud databases, cloud computing, cloud functions, cloud storage, and network services, cloud communications, middleware services, domain name services, security services, content delivery networks (CDN), big data, and artificial intelligence platforms. The terminal device 400 may be a smartphone, a tablet computer, a notebook computer, a desktop computer, a smart speaker, a smartwatch, a vehicle-mounted terminal, or the like, but is not limited thereto. The terminal device 400 and the server 200 may be connected directly or indirectly through wired or wireless communication, which is not limited in the present disclosure.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

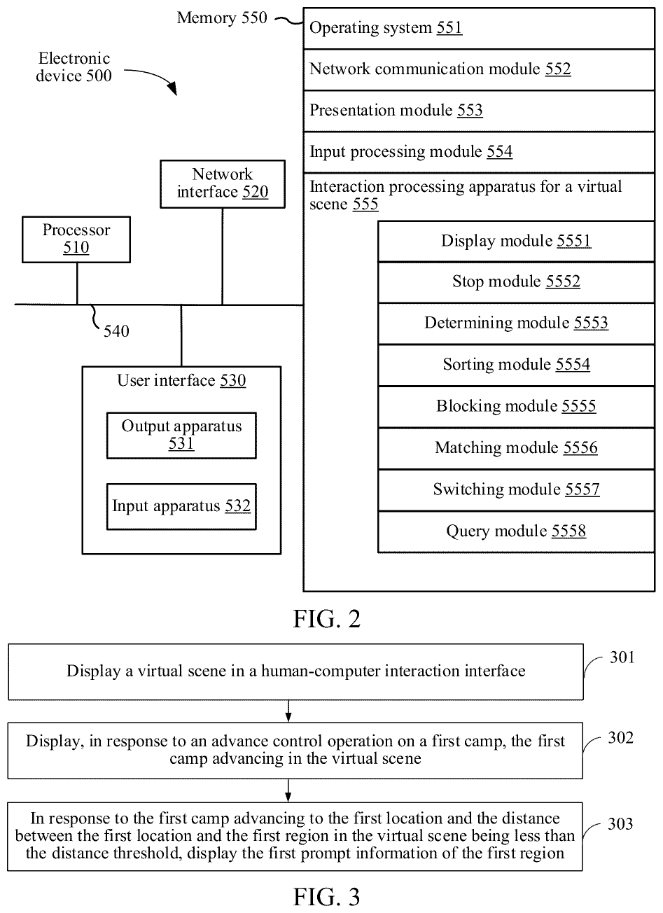

The following continues to describe the structure of the electronic device provided in the present disclosure. Taking an electronic device as a terminal device as an example, refer to FIG. 2. FIG. 2 is a schematic structural diagram of an electronic device 500 according to an embodiment of the present application. The electronic device 500 shown in FIG. 2 includes: at least one processor 510, a memory 550, at least one network interface 520, and a user interface 530. All components of the electronic device 500 are coupled by using a bus system 540. The bus system 540 is configured to implement connection and communication between the components. In addition to a data bus, the bus system 540 further includes a power bus, a control bus, and a state signal bus. However, for ease of clear description, all types of buses in FIG. 2 are marked as the bus system 540.

Processing circuitry, such as the processor 510 can be an integrated circuit chip with signal processing capabilities, such as a general-purpose processor, a digital signal processor (DSP), or other programmable logic devices, discrete gates or transistor logic devices, and discrete hardware components. The general-purpose processor can be a microprocessor or any conventional processor.

The user interface 530 includes one or more output apparatuses 531 that can display media content, and includes one or more speakers and/or one or more visual display screens. The user interface 530 further includes one or more input apparatuses 532, and includes user interface components that facilitate user input, such as a keyboard, a mouse, a microphone, a touch display screen, a camera, and other input buttons and controls.

The memory 550 may be a removable memory, a non-removable memory, or a combination thereof. Hardware devices include solid-state memories, hard disk drives, optical disk drives, and the like. In an aspect, the memory 550 may include one or more storage devices physically located away from the processor 510.

The memory 550 may be a volatile memory or a non-volatile memory, or may include both a volatile memory and a non-volatile memory. The non-volatile memory can be a read-only memory (ROM), and the volatile memory can be a random access memory (RAM). The memory 550 described in this disclosure aims to include any suitable type of memory.

For example, the memory 550 can store data to support various operations, and examples of the data include programs, modules, data structures, or subsets or supersets thereof, as described below.

The operating system 551 includes system programs for processing various basic system services and executing hardware-related tasks, such as a framework layer, a core library layer, and a driver layer, to implement various basic services and process hardware-based tasks.

The network communication module 552 is configured to reach other computing devices through one or more (wired or wireless) network interfaces 520. For example, the network interface 520 includes: Bluetooth, Wi-Fi, universal serial bus (USB), and the like.

The presentation module 553 is configured to display information through one or more output apparatuses 531 (for example, display screens or speakers) associated with the user interface 530 (for example, is configured to operate a peripheral device and a user interface that displays content and information).

The input processing module 554 is configured to detect one or more user inputs or interactions from one or more input apparatuses 532, and translate the detected inputs or interactions.

For example, the apparatus provided by the present disclosure can be implemented by software. FIG. 2 shows an interaction processing apparatus 555 for a virtual scene stored in the memory 550. The apparatus can be software in a form of program and plug-in and includes the following software modules: a display module 5551, a stop module 5552, a determining module 5553, a sorting module 5554, a blocking module 5555, a matching module 5556, a switching module 5557, and a query module 5558, where these modules are logical and therefore may be combined or further split in any manner according to implemented functions. In FIG. 2, all the above modules are shown for the convenience of description, but it is not considered as excluding an implementation in which the interaction processing apparatus 555 for a virtual scene only includes the display module 5551. A function of each module will be described below.

The interaction processing method for a virtual scene provided by the present disclosure will be described below in conjunction with the terminal device.

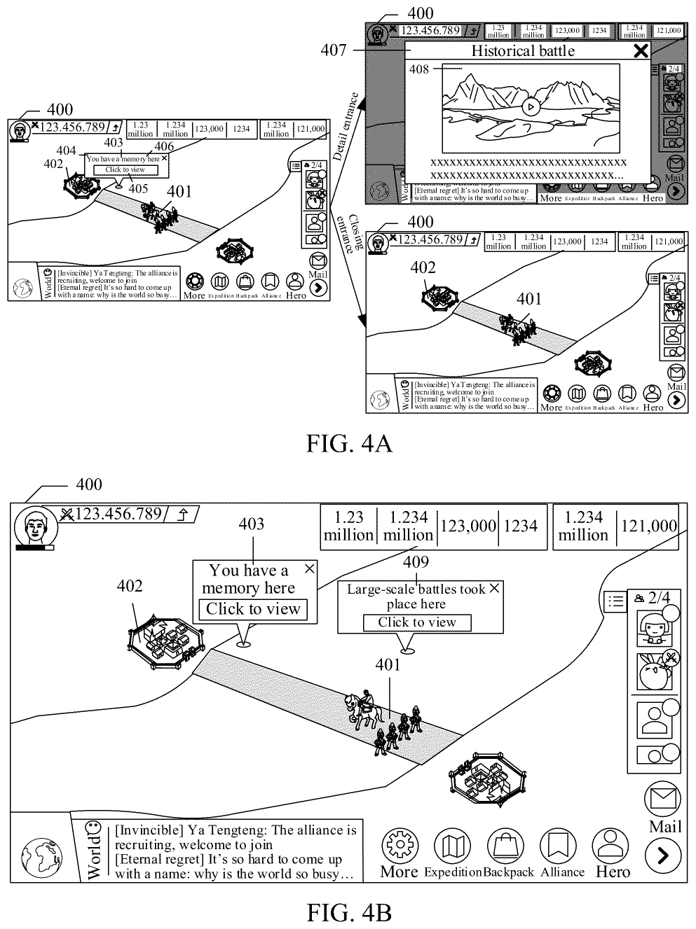

FIG. 3 is a schematic flowchart of an interaction processing method for a virtual scene according to an aspect of this disclosure. Operations shown in FIG. 3 will be described.

The method shown in FIG. 3 can be executed by various forms of computer programs running on the terminal device, and is not limited to be executed by a client, for example, can also be executed by the operating system, software modules, scripts, and mini programs mentioned above. Therefore, the example of the client below is not considered as limiting the present disclosure. In addition, for convenience of description, no specific distinction is made between the terminal device and the client running on the terminal device in the following.

In the following, for the convenience of description, it is assumed that different accounts are logged in in the virtual scene, and different accounts control different camps. A first account is logged in in the human-computer interaction interface below, and the first account controls a first camp. The first account and the first camp are only examples, and do not specifically refer to a specific account or a specific camp.

Operation 301: Display a virtual scene in a human-computer interaction interface.

Herein, the virtual scene may include multiple camps, where each camp may include at least one virtual object.

For example, a client (such as a strategy game APP) that supports virtual scenes is installed on the terminal device. When a user opens the client installed on the terminal device (for example, a click operation performed by the user on an icon corresponding to the strategy game APP presented on the user interface of the terminal device is received), and when the terminal device runs the client, the virtual scene can be displayed in the human-computer interaction interface of the client. The virtual scene can include multiple camps, for example, 4 camps: a camp 1, a camp 2, a camp 3, and a camp 4. Each camp may include at least one virtual object. For example, the camp 1 includes a virtual object A and a virtual object B, the camp 2 includes a virtual object C, the camp 3 includes a virtual object D and a virtual object E, and the camp 4 includes a virtual object F and a virtual object G.

In other examples, the human-computer interaction interface of the client may display the virtual scene from a first-person perspective (for example, the virtual object in the game is played from the perspective of the user), or display the virtual scene from a third-person perspective (for example, the user chases the virtual object in the game to play the game), or display the virtual scene from a bird's-eye perspective. The different viewing angles can be switched from one to another.

As an example, at least one virtual object (such as the virtual object A and the virtual object B) included in the first camp may be a virtual object controlled by the current user in the game. Certainly, the virtual scene may also include virtual objects included in other camps, such as virtual objects controlled by other users or robot programs. Virtual objects can be divided into any one of multiple camps, and the camps can have a hostile relationship or a cooperative relationship. The camps in the virtual scene can have one or all of the relationships.

Taking display of a virtual scene from a first-person perspective as an example, the displaying a virtual scene in a human-computer interaction interface may include: determining a field of view region of the first camp according to a viewing location and a field of view angle of at least one virtual object (for example, the virtual object A) included in the first camp in the complete virtual scene, and presenting a part of the complete virtual scene in the field of view region, that is, the displayed virtual scene may be a partial virtual scene relative to the panoramic virtual scene. Because the first-person perspective is the most impactful viewing perspective for users, users can achieve immersive perception during the operation.

Taking display of a virtual scene from a bird's-eye perspective as an example, the displaying a virtual scene in a human-computer interaction interface may include: in response to a scaling operation on the panoramic virtual scene, presenting a partial virtual scene corresponding to the scaling operation in the human-computer interaction interface, that is, the displayed virtual scene may be a partial virtual scene relative to the panoramic virtual scene. In this way, operability of the user during operation can be improved, thereby improving the efficiency of human-computer interaction.

Operation 302: Display, in response to an advance control operation on a first camp, the first camp advancing in the virtual scene.

For example, the player can log in to the human-computer interaction interface through a registered account (that is, the first account) to control at least one virtual object included in the first camp (for example, the camp A). For example, after the player logs in through the first account, when receiving an advance control operation triggered by the player on the camp A, the client can display at least one virtual object included in the camp A advancing in the virtual scene. For example, the player can first select a game character belonging to the camp A in the game, and then deliver a control instruction to the selected game character to advance to a specific direction. In this case, the game character included in the camp A advances to the direction specified by the control instruction.

Operation 303: In response to the first camp advancing to the first location and the distance between the first location and the first region in the virtual scene being less than the distance threshold, display the first prompt information of the first region.

Herein, the first prompt information represents that a first interaction event between multiple camps has occurred in the first region, such as a battle event between the first camp and the second camp of the multiple camps. In addition, the distance threshold (which refers to a length of a two-dimensional or three-dimensional straight line in the map of the virtual scene) can be preset by a planner. The distance threshold can be set to 0, that is, when the distance threshold is set to 0, only when the player controls the first camp to advance to the boundary of the first region, the first prompt information of the first region is displayed in the human-computer interaction interface. Certainly, the distance threshold can also be set to any integer greater than 0. For example, when the distance threshold is set to 5, when detecting that the distance between the first camp and the first region is less than or equal to 5, the client displays the first prompt information of the first region in the human-computer interaction interface.

The first interaction event in this disclosure is a collective name for interaction events that have occurred in the first region. That is, the interaction events that have occurred in the first region of the virtual scene are collectively referred to as the first interaction event, which does not specifically refer to an interaction event that has occurred in the virtual scene. For example, assuming that an interaction event 1 and an interaction event 2 have occurred in the first region, both the interaction event 1 and the interaction event 2 are referred to as the first interaction event.

For example, a type of the first interaction event may include at least one of the following: an interaction event in which the first account participates (such as a historical battle event or a historical collaboration event in which the player participates), an interaction event in which the second account that has a social relationship with the first account participates (such as a historical battle event in which friends of the player or other players that the player follows participate), and an interaction event in which any account participates and whose popularity reaches (that is, is greater than or equal to) the popularity threshold (for example, a historical combat event in the game whose duration is greater than or equal to the duration threshold, or a historical battle event in which the number of participating camps is greater than or equal to the number threshold, or a historical combat event in which the number of participating virtual objects is greater than or equal to the number threshold).

In some other embodiments, the first prompt information may be information carried in an information display control, where the information display control may include a detail entrance and a closing entrance, and the terminal device may further perform the following processing: displaying detail information of the first interaction event in response to a triggering operation on the detail entrance, such as a video, a picture, a text, and other information used to introduce the first interaction event; and stopping displaying the first prompt information in response to a triggering operation on the closing entrance, for example, directly canceling display of the information display control.

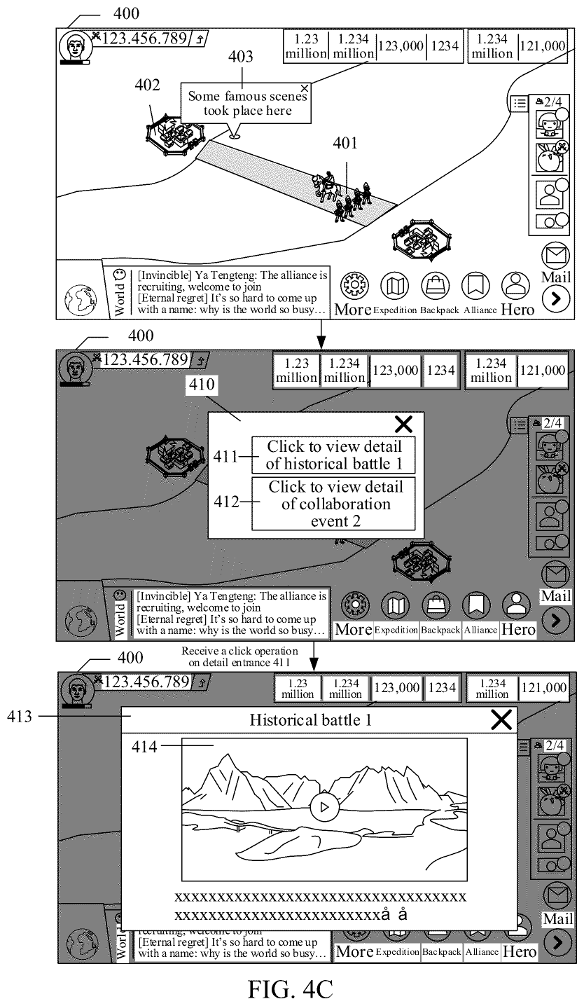

For example, refer to FIG. 4A. FIG. 4A is a schematic diagram of an interaction processing method for a virtual scene according to an embodiment of the present application. As shown in FIG. 4A, when a distance between a first camp 401 and a first region 402 in a virtual scene 400 is less than a distance threshold, first prompt information 403 of the first region can be displayed in the virtual scene 400, such as “you have a memory here”. The first prompt information 403 is carried in an information display control 404, and the information display control 404 includes a detail entrance 405 (such as a “click to view” button) and a closing entrance 406 (such as an “x” button). When the client receives a click operation performed by the user on the detail entrance 405, a pop-up window 407 can be displayed in the virtual scene 400, and a video 408 for introducing a battle event that has occurred in the first region 402 can be displayed in the pop-up window 407. Users can learn about the historical battle event that has occurred in the first region 402 through the video 408. When the client receives a click operation performed by the user to close the closing entrance 406, display of the information display control 404 can be canceled in the virtual scene 400.

In addition to being displayed in the virtual scene (for example, the first prompt information of the first region is displayed in the first region, or the first prompt information of the first region is displayed in a floating manner in the virtual scene), the first prompt information may also be displayed in a split-screen manner, for example, the first prompt information of the first region can be displayed in a first window of the human-computer interaction interface, where the first window is different from a second window used to prompt the image of the virtual scene.

For example, it can be determined, based on the size of the display screen of the terminal device, whether to divide the human-computer interaction interface into two different windows. For example, when the size of the display screen (for example, the length of the diagonal line of the display screen) is greater than a size threshold (for example, 20 inches), the human-computer interaction interface can be divided into two windows in advance. The first window is configured for displaying the virtual scene, and the second window is configured for displaying the first prompt information of the first region and the detail information of the first interaction event. In this way, interference to the current game screen of the user can be avoided to the greatest extent. When the size of the display screen is less than or equal to the size threshold, the human-computer interaction interface may not be divided, and the first prompt information of the first region may be directly displayed in the virtual scene. This disclosure does not specifically limit the display manner of the first prompt information.

For example, the first prompt information may be displayed only in a specific time period, and the terminal device may implement the above operation 303 in the following manner: in response to the first camp advancing to the first location and the distance between the first location and the first region in the virtual scene being less than the distance threshold, displaying the first prompt information of the first region in at least one of the following time periods: a first time period of advancing from the first location to reach the boundary of the first region; a second time period spent in the first region; and a third time period of leaving the first region and advancing to a second location.

For example, the first camp is a camp A and the first region is a region 1. Prompt information of the region 1 may be displayed in a first time period in which a player controls the camp A to advance from a first location to the boundary of the region 1 (that is, the prompt information of the region 1 is displayed in the first time period in which the player controls the camp A to approach the boundary of the region 1 from the first location). Certainly, the prompt information of the region 1 can also be displayed in a second time period in which the player controls the camp A to stay in the region 1 (that is, the prompt information of the region 1 is displayed in the second time period in which the player controls the camp A to stay in the region 1). In addition, the prompt information of the region 1 can also be displayed in a third time period in which the player controls the camp A to leave the region 1 and continue to advance to a second location (a distance between the second location and the region A is less than a distance threshold) (that is, the prompt information of the region 1 is displayed in the third time period in which the player controls the camp A to leave the region 1 and advance to the second location). In this way, interference to a normal game process of the player due to long-time display of the prompt information can be avoided.

The durations of the first time period and the third time period may be the same, for example, both are 10 seconds, that is, the first prompt information of the first region is displayed within 10 seconds before and after reaching the first region. Alternatively, lengths of advancing routes in the first time period and the third time period are the same, for example, 20 meters.

In addition, the first prompt information may also be displayed in the human-computer interaction interface after the first camp moves to the first location until the first region is no longer displayed in the human-computer interaction interface. Taking the first region as the region 1 as an example, when the player controls the first camp to advance to the first location whose distance from the region 1 is less than the distance threshold 1, the prompt information of the region 1 can be displayed in the human-computer interaction interface, until the region 1 disappears from the human-computer interaction interface as the first camp continues to advance. This disclosure does not specifically limit the display time period of the first prompt information.

For example, only prompt information corresponding to one region can be displayed in the human-computer interaction interface at a same time, and when displaying the first prompt information of the first region, the terminal device can further perform the following processing: switching, according to a region sorting manner, to display prompt information of a next region of the first region in response to the detail information of the first interaction event not being viewed; or switching, according to a region sorting manner, to display prompt information of a next region of the first region in response to the detail information of the first interaction event being viewed and a display duration of the detail information of the first interaction event reaching a display duration threshold (for example, 20 seconds).

For example, the first prompt information may be carried in an information display control, where the information display control may include a detail entrance (for example, the “click to view” button shown in FIG. 4A) and a closing entrance (for example, the x″ button shown in FIG. 4A). When a triggering operation on the closing entrance is received, or a triggering operation on the detail entrance is not received in a first set duration (for example, 15 seconds) (that is, the detail information of the first interaction event is not viewed), switching may be performed, according to the region sorting manner, to display the prompt information of the next region of the first region (for example, switching is performed to display the prompt information of the second region closest to the first region). When a trigger operation on the detail entrance is received (that is, the detail information of the first interaction event is viewed) and the display duration of the detail information of the first interaction event reaches the display duration threshold, or a closing operation on the detail information of the first interaction event is received, switching is performed to display the prompt information of the next region of the first region according to the region sorting manner (for example, switching is performed to display prompt information of a third region with the greatest similarity to the first region). In this way, the user can more efficiently view other regions in the virtual scene, thereby improving user game experience.

The region (or referred to as a hot region) in this disclosure refers to a region in which an interaction event has occurred in the virtual scene, and the region sorting method may include: an ascending order of distances between multiple regions and the first camp (that is, priority is given to switch to display the prompt information of the region with a smaller distance from the first camp), for example, assuming that three regions are to be displayed: a region 2, a region 3, and a region 4, the region 3 is the closest to the first camp, the region 2 is the second closest, and the region 4 is the farthest from the first camp, the switching display order of the three regions is: the region 3, the region 2, and the region 4, for example, after the detail information of the first interaction event that has occurred in the first region is viewed, switching may be performed to first display the prompt information of the region 3; and an descending order of scores corresponding to multiple regions (that is, priority is given to switch to display prompt information of a region with a higher score, for example, assuming that three regions are to be displayed: the region 2, the region 3, and the region 4, and the score of the region 2 is 80, the score of the region 3 is 70, and the score of the region 4 is 90, the switching display order of the three regions is: the region 4, the region 2, and the region 3, for example, when the user does not view the first interaction event that has occurred in the first region, switching may be performed to first display the prompt information of the region 4), where the score of each region can be determined based on at least one of the following information of the region: whether the first camp has reached the region, similarity between the characteristic of the interaction event that has occurred in the region and the characteristic of the first account (for example, similarity between the interaction event that has occurred in the region and the interest of the player, that is, it is determined whether the player is interested in the interaction event that has occurred in the region), and scale of the interaction event that has occurred in the region, for example, a duration of the event, a number of participating camps, or a number of participating virtual objects. The first account is configured for logging in to the human-computer interaction interface to control at least one virtual object included in the first camp.

In some other embodiments, prompt information corresponding to multiple regions can also be displayed in the human-computer interaction interface at the same time, and when displaying the first prompt information of the first region, the terminal device can further perform the following processing: displaying prompt information respectively corresponding to multiple regions located on at least one side of an advance route of the first camp; alternatively, prompt information corresponding to multiple regions within the field of view of the first camp is displayed. For example, the field of view can be the field of view of any virtual object included in the first camp, or a comprehensive field of view obtained based on field of view of multiple virtual objects included in the first camp.

For example, refer to FIG. 4B. FIG. 4B is a schematic diagram of an interaction processing method for a virtual scene according to an embodiment of the present application. As shown in FIG. 4B, when the user controls multiple virtual objects included in the first camp 401 to advance to the first location whose distance from the first region 402 is less than the distance threshold, in addition to displaying the first prompt information 403 of the first region in the virtual scene 400, prompt information of other regions within the field of view of the first camp 401 can also be displayed in the virtual scene 400, for example, second prompt information 409 of the second region. In this way, by displaying prompt information corresponding to multiple regions at a time, the user can more efficiently view regions in the virtual scene.

When displaying prompt information corresponding to multiple regions at the same time, the prominence of the prompt information of different regions may be different. For example, if a region is closer to the first camp, prompt information is displayed more prominently, for example, a size of the information display control for carrying the prompt information is larger, making it convenient for users to view.

For example, based on the above example, the score of the region can be calculated based on an explicit rule. When the number of multiple regions is greater than the number threshold (for example, 5), the terminal device can further perform the following processing: determining scores of the multiple regions, and performing descending sorting according to the scores of the multiple regions to obtain a descending sorting result; and displaying prompt information respectively corresponding to a first number (for example, 3) of regions starting from the first place in the descending sorting result, to replace display of the prompt information respectively corresponding to the multiple regions, where the first number is smaller than the total number of the multiple regions. The score of each region is determined in the following manner: performing quantitative processing on whether the first camp has reached the region (for example, if the first camp has reached the region, the corresponding quantitative value can be 1, or if the first camp has not reached the region, the corresponding quantitative value can be 0), the similarity between the characteristic of the interaction event that has occurred in the region (such as the type of the interaction event, including battle or collaboration between different camps) and the characteristic of the first account (such as the tag of the first account) (for example, the similarity can be normalized to an interval between 0 and 1, and the normalized similarity can be determined as the corresponding quantitative value, for example, assuming that the similarity is 80%, the corresponding quantitative value is 0.8), and the scale of the interaction event that has occurred in the region (when the scale is represented by the duration of the interaction event, the result of dividing the duration and a set duration can be determined as the corresponding quantitative value, for example, assuming that the duration of the interaction event is 8 minutes and the set duration is 10 minutes, the corresponding quantitative value is 0.8, certainly, when the scale is represented by the number of participating camps, the result of dividing the number of participating camps by the set number of camps can be determined as the corresponding quantitative value, for example, assuming that the number of participating camps is 4 and the set number of camps is 5, the corresponding quantization value is 0.8, similarly, when the scale is represented by the number of participating virtual objects, the result of dividing the number of participating virtual objects by the set number of objects can be determined as the corresponding quantitative value, for example, assuming that the number of participating virtual objects is 8 and the set number of objects is 10, the corresponding quantitative value is 0.8), to correspondingly obtain multiple quantitative values, where the first account is configured for logging in to the human-computer interaction interface to control at least one virtual object included in the first camp; and performing weighted summation processing on the multiple quantitative values, and determining an obtained weighted summation result as the score of the region, which can avoid displaying prompt information corresponding to an excessively large number of regions in the virtual scene and interfering the normal game process of the user.

For example, taking the region 2 of the multiple regions as an example, after performing quantitative processing on whether the first camp has reached the region 2, the similarity between the characteristic of the interaction event that has occurred in the region 2 and the characteristic of the first account, and the scale of the interaction event that has occurred in the region 2, three quantitative values are correspondingly obtained. Assuming that the values are 1, 0.7, and 0.8, weighted summation processing may be performed on the three quantitative values, and the obtained weighted summation result (for example, assuming that the weight corresponding to each quantitative value is 0.6, the corresponding weighted summation result is 0.6×1+0.6×0.7+0.6×0.8=1.5) is determined as the score of the region 2 (that is, the score of the region 2 is 1.5).

When performing weighted summation processing on multiple quantitative values, weights of different quantitative values can be the same, for example, are all 0.6. Certainly, the weights corresponding to different quantitative values may also be different. For example, the weight of each quantitative value may be separately configured by the planner, which is not specifically limited in the present disclosure.

In addition, in the process of performing quantitative processing on the scale of an interaction event that has occurred in a region, in addition to a separate duration, a separate number of participating camps, and a separate number of participating virtual objects, a comprehensive duration, a comprehensive number of participating camps, and a comprehensive number of participating virtual objects may also be used to determine the corresponding quantitative value, which is not specifically limited in the present disclosure.

In other embodiments, the score of a region can also be determined through artificial intelligence. In this case, when the number of multiple regions is greater than the number threshold (for example, 5), the terminal device can further perform the following processing: determining scores of the multiple regions, and performing descending sorting according to the scores of the multiple regions to obtain a descending sorting result; and displaying prompt information respectively corresponding to a first number (for example, 3) of regions starting from the first place in the descending sorting result, to replace display of the prompt information respectively corresponding to the multiple regions, where the first number is smaller than the total number of the multiple regions. The score of each region is determined in the following manner: calling a machine learning model based on information of the region (for example, whether the first camp has reached the region, the scale of the interaction event that has occurred in the region, and the similarity between the characteristic of the interaction event that has occurred in the region and the characteristic of the first account) for prediction processing to obtain the score of the region, where the machine learning model is trained based on multiple sample regions, and initial scores of the multiple sample regions are calculated based on a rule, for a sample region that is subsequently viewed among the multiple sample regions, increasing the score of the sample region that is viewed (for example, assuming that an initial score of a sample region is 1.2 and the sample region is subsequently viewed, it indicates that the user is interested in the interaction event that has occurred in the sample region, and therefore the score of the sample region can be increased to 1.4), for a sample region that is not subsequently viewed among the multiple sample regions, reducing the score of the sample region that is not viewed (for example, assuming that an initial score of a sample region is 1.5 and the sample region is not subsequently viewed, it indicates that the user is not interested in the interaction event that has occurred in the sample region, and therefore the score of the sample region can be reduced to 1.3), and using the multiple sample regions with updated scores as new sample regions to iteratively train the machine learning model.

The machine learning model can be trained by the server. For example, the server can train the machine learning model based on multiple sample regions and send the trained machine learning model to the terminal device. In addition, the type of the machine learning model can be a neural network model (such as a convolutional neural network model, a deep convolutional neural network model, or a fully connected neural network model), a decision tree model, a gradient boosting tree model, a multi-layer perceptron, a support vector machine, or the like. The present disclosure do not specifically limit the type of the machine learning model.

In the present disclosure, the machine learning model may be trained based on various types of loss functions, such as a regression loss function, a binary loss function, a hinge loss function, a multi-class loss function, and a multi-class cross-entropy loss function.

For example, multi-class cross-entropy loss is generalization of binary cross-entropy loss. Loss of an input vector Xᵢ and a corresponding one-hot encoded target vector Yᵢ is:

$$L ( {X}_{i} , {Y}_{i} ) = - {\sum }_{j = 1}^{c} {y}_{ij} * log ( {p}_{ij} ) \qquad ( 1 )$$

pᵢⱼ represents a probability corresponding to the i^{th} input vector in a set j, c represents a total number of input vectors, and yᵢⱼ represents an output corresponding to the i^{th} input vector.

For example, hinge loss is mainly used for support vector machines with class tags (for example, including 1 and 0, where 1 represents victory and 0 represents failure). For example, the hinge loss of a data pair (x, y) is calculated as follows:

$$L = max ( 0 , 1 - y * f ( x ) ) \qquad ( 2 )$$

y represents a true value, f(x) represents a predicted value, and hinge loss simplifies the mathematical operation of the support vector machine while maximizing the loss.

In other embodiments, when different types of first interaction events have occurred in the first region, the terminal device may further perform the following processing: displaying detail entrances respectively corresponding to the first interaction events of different types in the first prompt information; and displaying detail information of the first interaction event of any type in response to a triggering operation on a detail entrance corresponding to the first interaction event of the type.

For example, assuming that two different types of first interaction events have occurred in the first region: a battle event 1 between a camp A and a camp B, and a collaboration event 2 between a camp C and a camp D, detail entrances corresponding to the battle event 1 and the collaboration event 2 can be displayed in the first prompt information, for example, two detail entrances are displayed. A detail entrance 1 is a detail entrance corresponding to the battle event 1, and a detail entrance 2 is a detail entrance corresponding to the collaboration event 2. When a trigger operation by the user on the detail entrance corresponding to the battle event 1 is received (that is, a click operation on the detail entrance 1 is received), the detail information of the battle event 1 can be displayed in the human-computer interaction interface, for example, a video for introducing the battle event 1 is displayed.

In other embodiments, when different types of first interaction events have occurred in the first region, the terminal device may further perform the following processing: in response to a triggering operation on the first prompt information, displaying detail entrances corresponding to different types of first interaction events (for example, when a click operation on the first prompt information is received, a pop-up window can be displayed in the virtual scene, and the pop-up window displays the detail entrances corresponding to the different types of first interaction events); and displaying detail information of the first interaction event of any type in response to a triggering operation on a detail entrance corresponding to the first interaction event of the type.

For example, assuming that two different types of first interaction events have occurred in the first region: a battle event 1 between a camp A and a camp B, and a collaboration event 2 between a camp C and a camp D, when receiving a triggering operation on the first prompt information, the terminal device can display a pop-up window in the human-computer interaction interface, and display the detail entrance 1 corresponding to the battle event 1 and the detail entrance 2 corresponding to the collaboration event 2 in the pop-up window. Subsequently, assuming that a click operation performed by the user on the detail entrance 2 displayed in the pop-up window is received, detail information for introducing the collaboration event 2 can be displayed in the human-computer interaction interface, such as graphic and text information for introducing the collaboration event 2.

For example, refer to FIG. 4C. FIG. 4C is a schematic diagram of an interaction processing method for a virtual scene according to an embodiment of the present application. As shown in FIG. 4C, when the user controls the first camp 401 to advance to the first location (located on one side of the advance route) whose distance from the first region 402 in the virtual scene 400 is smaller than the distance threshold, the first prompt information 403 of the first region can be displayed in the virtual scene 400. Then, in response to a click operation performed by the user on the first prompt information 403, the client displays a pop-up window 410 in the virtual scene 400. The pop-up window 410 displays a detail entrance 411 corresponding to the historical battle 1 that has occurred in the first region 402, such as a “click to view the detail of the historical battle 1” button, and a detail entrance 412 corresponding to the collaboration event 2 that has occurred in the first region 402, such as a “click to view detail of the collaboration event 2” button. For example, assuming that the client subsequently receives a click operation performed by the user on the detail entrance 411, a pop-up window 413 can be displayed in the virtual scene 400, and a video 414 for introducing the historical battle 1 can be displayed in the pop-up window 413. In this way, corresponding detail entrances are displayed for different types of first interaction events, so that the user can more efficiently view the interaction event that has occurred in the first region.

For example, when displaying the first prompt information of the first region, the terminal device may further perform the following processing: displaying the detail information of the first interaction event in response to a number of the first interaction events that have occurred in the first region being less than a number threshold (for example, 3) and the first camp not currently interacting with another camp (for example, any faction of the multiple camps other than the first camp), to replace display of the first prompt information, where the detail information is used to introduce the first interaction event (for example, a video for introducing the first interaction event); and stopping displaying the detail information of the first interaction event in response to a closing operation on the detail information of the first interaction event, or the display duration of the detail information of the first interaction event reaching a display duration threshold (for example, 10 seconds).

For example, refer to FIG. 4D. FIG. 4D is a schematic diagram of an interaction processing method for a virtual scene according to an embodiment of the present application. As shown in FIG. 4D, when the user controls the first camp 401 to advance to the first location whose distance from the first region 402 in the virtual scene 400 is smaller than the distance threshold, the number of first interaction events that have occurred in the first region 402 is less than the number threshold, and the first camp 401 currently does not interact with other camps (for example, the client detects that the distance between the first camp 401 and the first region 402 is less than the distance threshold and only one interaction event has occurred in the first region 402, and detects that the first camp 401 currently only advances and does not interact with other camps), a pop-up window 407 can be directly displayed in the virtual scene 400, and the detail information of the first interaction event that has occurred in the first region 402 can be displayed in the pop-up window 407, for example, a video 408 for introducing the first interaction event (a historical battle that has occurred in the first region 402). In addition, a closing entrance 415 is also displayed in the pop-up window 407, such as a “x” button. When the subsequent display duration of the video 408 is greater than the display duration threshold (for example, playing of the video 408 has been completed) or a click operation performed by the user on the closing entrance 415 displayed in the pop-up window 407 is received, the terminal device can cancel the display of the pop-up window 407 in the virtual scene 400.

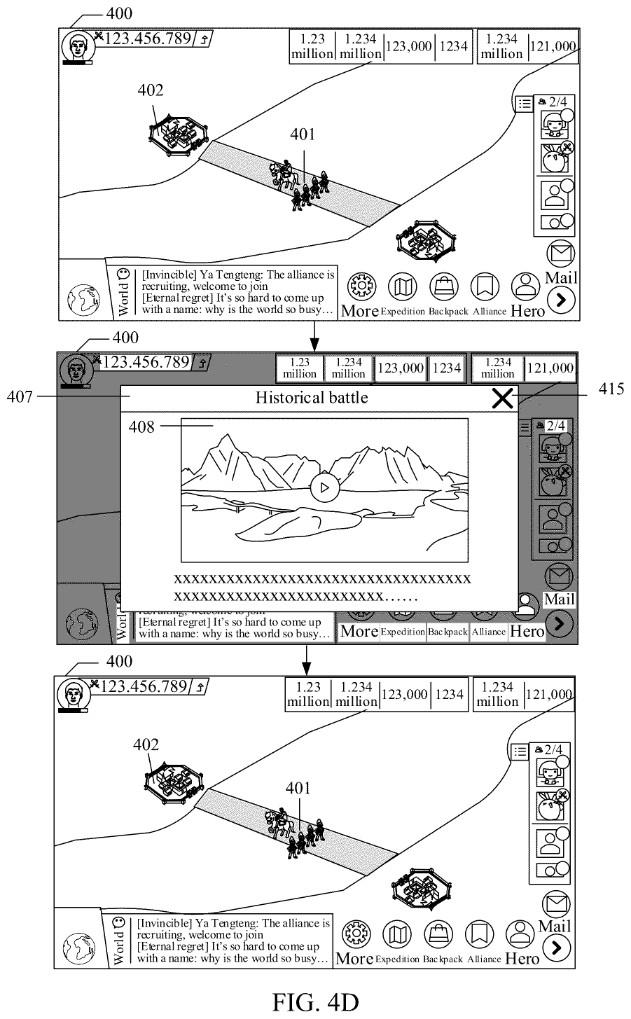

For example, refer to FIG. 5A. FIG. 5A is a schematic flowchart of an interaction processing method of a virtual scene according to an embodiment of the present application. As shown in FIG. 5A, after operation 303 in FIG. 3, operation 304 to operation 305 in FIG. 5A may be further performed. Operations in FIG. 5A will be described.

Operation 304: Display second prompt information of a second region in the first prompt information in response to there being similarity between the second region and the first region in the virtual scene.

Herein, the second prompt information represents that a second interaction event between the multiple camps has occurred in the second region.

For example, taking the first region as the region 1 in the virtual scene as an example, when the terminal device detects that a second region (for example, the region 2) is similar to the region 1 in the virtual scene (for example, a terrain feature of the region 2 is the same as that of the region 1, for example, the region 1 and the region 2 are both grassland, a map outline of the region 2 is similar to that of the region 1, and the type of a historical interaction event that has occurred in the region 2 is the same as that of a historical interaction event that has occurred in region 1), it indicates that the region 2 may also be a region that the user is interested in. In this case, the prompt information of the region 2 may be displayed in the prompt information of the region 1, so that the user can more efficiently view interaction events that have occurred in different regions of the virtual scene, and the user experience can be improved.

Operation 305: Display that there is similarity between the first region and the second region in at least one of the following dimensions: terrain features, map outlines, camp distribution, and historical interaction events that have occurred.

For example, still taking the first region being the region 1 in the virtual scene and the second region being the region 2 in the virtual scene as an example, when displaying the prompt information of the region 2 in the prompt information of the region 1, the terminal device may further display a reason for recommending the region 2, for example, display that the region 1 and the region 2 are similar in at least one of the following dimensions: terrain features (for example, the following information can be displayed: the terrain feature of the region 2 is the same as that of the region 1), map outlines (for example, the following information can be displayed: the map outline of the region 2 is similar to that of the region 1), camp distribution (for example, the following information can be displayed: camp distribution in the region 2 is similar to that in the region 1), and historical interaction events that have occurred (for example, the following information can be displayed: a type and a scale of the interaction event that has occurred in the region 2 are similar to those in the region 1). In this way, the time of searching for similar regions in the virtual scene by the user can be effectively saved, and the user experience is improved.

For example, before displaying the first prompt information, the terminal device may further perform the following processing: displaying a push setting control of the first prompt information in the human-computer interaction interface, where the push setting control includes at least one of the following: a region setting control, configure for setting an introduction-allowed region (that is, when the user controls the first camp to move to a location whose distance from the region is less than the distance threshold, the prompt information of the region is displayed in the human-computer interaction interface) and an introduction-forbidden region (that is, when the user controls the first camp to move to a location whose distance from the region is less than the distance threshold, the prompt information of the region is not displayed in the human-computer interaction interface) in the virtual scene, where an interaction event that has occurred in the introduction-allowed region can be introduced through corresponding introduction information, and an interaction event that has occurred in the introduction-forbidden region cannot be introduced through corresponding introduction information; a data format setting control, configure for setting a data format that is allowed to be pushed, where the data format includes at least one of the following: a video, an image, and a text; an event type setting control, configure for setting an event type that is allowed to be pushed, where the event type includes at least one of the following: an interaction event in which a first account participates, an interaction event in which a second account that has a social relationship with the first account participates, and an interaction event that reaches a popularity threshold (for example, an interaction event whose duration is longer than the duration, a number of participating camps is greater than a number threshold, and a number of participating objects is greater than a number threshold), where the first account is configured for logging in to the human-computer interaction interface to control at least one virtual object included in the first camp; and a time period setting control, configured for setting a time period during which push is allowed or forbidden (for example, push is allowed during a process of controlling the movement of the first camp, and push is forbidden during a battle between the first camp and other camps).

In some other embodiments, refer to FIG. 5B. FIG. 5B is a schematic flowchart of an interaction processing method of a virtual scene according to an embodiment of the present application. As shown in FIG. 5B, after operation 303 in FIG. 3, operation 306 and operation 307 in FIG. 5B may be further performed. Operations in FIG. 5B will be described.

Operation 306: Block display of the first prompt information of the first region in response to the detail information of the first interaction event not being viewed and the first camp again advancing to the first location whose distance from the first region is less than a distance threshold.

For example, the first prompt information may be carried in an information display control, where the information display control includes a detail entrance and a closing entrance. When the terminal device receives a click operation performed by the user on the closing entrance, or receives, within a set time period, no click operation performed by the user on the detail entrance (that is, the detail information of the first interaction event is not viewed), it indicates that the user is not interested in the first interaction event. Then, when detecting that the first camp moves to the first location again whose distance from the first region is less than the distance threshold, the terminal device may block display of the first prompt information of the first region. This can prevent information that the user is not interested in from being repeatedly pushed to the user, thereby improving the user experience.

Operation 307: Display detail information of a new interaction event that has occurred in the first region.

Herein, the new interaction event occurs in a time period in which the first camp left the first region.

For example, in the above example, when detecting that the first camp moves to the first location again whose distance from the first region is less than the distance threshold, while blocking the display of the first prompt information of the first region, the terminal device can display, in the human-computer interaction interface, the detail information of the new interaction event that has occurred in the first region, for example, display a video introducing the new interaction event. In this way, by pushing the detail information of the new interaction event to the user, on the one hand, it can enrich the interaction methods of the virtual scene, and on the other hand, it can improve user game experience.

In other embodiments, before displaying the first prompt information of the first region, the terminal device may further perform the following processing: matching the characteristic (such as a type and a scale) of the first interaction event with a tag set of the first account, where the first account is configured for logging in to the human-computer interaction interface to control at least one virtual object in the first camp; switching to perform processing of displaying the first prompt information of the first region in response to a tag in the tag set matching the characteristic of the first interaction event; and blocking display of the first prompt information of the first region in response to no tag in the tag set matching the characteristic of the first interaction event (that is, the first prompt information of the first region is not displayed).

For example, the first interaction event is an interaction event 1. When the terminal device detects that the distance between the first camp and the first region is less than the distance threshold, the terminal device may first compare the characteristic of the interaction event 1 with the tag set of the first account. When a tag in the tag set matches the characteristic of the interaction event 1, it means that the interaction event 1 is an interaction event that the user is interested in, and the first prompt information of the first region can be displayed in the human-computer interaction interface. When no tag in the tag set matches the characteristic of the interaction event 1, it means that the interaction event 1 is not an interaction event that the user is interested in, and the first prompt information of the first region is not displayed in the human-computer interaction interface. In this way, by only pushing the interaction event that the user is interested in to the user, it can further improve the user experience while saving computing resources and communication resources on the terminal device and a server.

The following describes a process of determining the tag set of the first account.

For example, the terminal device may determine the tag set of the first account in the following manner: obtaining information of multiple dimensions of the first account, where the information of multiple dimensions includes: browsing information (for example, keyword extraction processing can be performed on the obtained browsing information, and the extracted keyword is used as a corresponding tag), behavioral habits (for example, user behavioral habits can be analyzed, and the obtained user characteristic data is used as a corresponding tag), a strategy whose usage frequency reaches the frequency threshold in the virtual scene (for example, a game strategy commonly used by the player can be analyzed to obtain the tag corresponding to the user, for example, when the player often uses an offensive strategy in the game, “like battling” may be used as the tag corresponding to the player), a region in which a duration of controlling the first camp to stay reaches a duration threshold (that is, a stay place frequently used by the player in the game, for example, the stay place frequently used by the player in the game can be analyzed to obtain a tag corresponding to the player, for example, assuming that the player often makes a virtual object in the camp controlled by the player stay in the battle region, it indicates that the player likes to battle with other players, and “like battling” can be used as the tag corresponding to the player), and a type of information followed by the first account (for example, a type of information followed by the user can be directly used as the tag corresponding to the user, for example, assuming that the user follows how to quickly defeat the enemy camp, “like battling” can be used as the tag corresponding to the player); performing tag extraction processing on the information of the multiple dimensions respectively, to obtain multiple tags correspondingly; and performing deduplication processing (that is, only one of tags of the same type is reserved) on the multiple tags to obtain the tag set of the first account.

For example, when there are multiple first interaction events and tags in the tag set respectively match characteristics of a second number of first interaction events, the terminal device may further perform the following processing: sorting the second number of first interaction events to obtain a sorting result, where the second number is less than or equal to the total number of the multiple first interaction events, and a sorting manner includes: a descending order of scales of the second number of first interaction events, and an ascending order of differences between occurrence times of the second number of first interaction events and a current time, where the sorting result is configured for indicating display priorities of detail information of the second number of first interaction events.

For example, it is assumed that 5 first interaction events have occurred in the first region: an interaction event 1, an interaction event 2, an interaction event 3, an interaction event 4, and an interaction event 5. It is also assumed that tags in the tag set of the first account match characteristics of the interaction event 2 and the interaction event 4 (that is, it indicates that both the interaction event 2 and the interaction event 4 are interaction events that the user is interested in). In this case, the terminal device can also perform the following processing: sorting the interaction event 2 and the interaction event 4 to obtain a sorting result, where the sorting manner includes: a descending order of scales of the interaction event 2 and the interaction event 4, for example, assuming that the duration of the interaction event 2 is 5 minutes and the duration of the interaction event 4 is 10 minutes, the sorting result of these two interaction events is: the interaction event 4 and the interaction event 2. Certainly, sorting may also be performed in ascending order of differences between the occurrence times of the interaction event 2 and the interaction event 4 and the current time. For example, assuming that the interaction event 2 occurred 5 days ago and the interaction event 4 occurred 7 days ago, the sorting result of these two interaction events is: the interaction event 2 and the interaction event 4. The sorting result is used to indicate the display priorities of the detail information of the interaction event 2 and the interaction event 4. For example, when the sorting result is: the interaction event 4 and the interaction event 2, when the terminal device receives a triggering operation on the first prompt information, the terminal device first displays the detail information of the interaction event 4, and when the display duration of the detail information of the interaction event 4 is greater than the display duration threshold, or the terminal device receives a closing operation on the detail information of the interaction event 4, the terminal device displays the detail information of the interaction event 2.

For example, each region in the virtual scene in which an interaction event has occurred has a corresponding identifier. Then, after the terminal device receives a triggering operation on the first prompt information (for example, the first prompt information may be carried in the information display control, the information display control includes a detail entrance, and the terminal device receives the click operation performed by the user on the detail entrance), the terminal device can also perform the following processing: querying, based on an identifier of the first region, detail information of the first interaction event that has occurred in the first region from a database, where the database pre-stores an identifier corresponding to each of the regions in the virtual scene and detail information of the interaction event that has occurred in each of the regions.

For example, assuming that the first region is the region 1 in the virtual scene, after receiving a triggering operation performed by the user on the prompt information of the region 1, the terminal device can query, in a database based on the identifier (for example, a serial number) of the region 1, detail information of the first interaction event that has occurred in the region 1, and perform display in the human-computer interaction interface based on the detail information obtained from the query.

According to the interaction processing method for a virtual scene provided by the embodiments of the present application, when the user controls the first camp to advance to the first location near a region (for example, the first region) in which an interaction event has occurred in the virtual scene, the first prompt information of the first region may be displayed in the human-computer interaction interface. On the one hand, the user can more efficiently view the interaction event that has occurred in the virtual scene. On the other hand, by pushing prompt information of the interaction event bound to the region, interaction methods of the virtual scene are enriched and game experience of the user is improved.

The present disclosure provides an interaction processing method for a virtual scene. In strategy games (SLG), video or text information (corresponding to detail information of the above interaction event) of player historical battles (corresponding to the above interaction event) is recorded and stored in the database. When the player commands a team (corresponding to the above camp) to conduct a battle march on the map and pass through a region, prompt information is displayed on the map, and when a triggering operation on the prompt information is received, detail information of the interaction event can be displayed, such as video or text information related to the player, including detail information of the player, friends of the player, the alliance of the player, enemies, or historical battle events involving other players followed by the player.

For example, in the map of the SLG game, when the player commands the team to march through some regions of the map, touchable prompt information appears, and the number of prompt information displayed on a single screen can be controlled (for example, each screen can display up to 3 pieces of prompt information). The player can choose to click to view or close the prompt information (the player can make selection and the player is not forced to view). When receiving a click operation performed by the player on the prompt information, a pop-up window can be displayed, and detail information of battle events that are related to the player or other players and in line with behavioral preferences of the player (such as videos, pictures, and texts for introducing the battle event) is displayed in the pop-up window. In this way, players can gain battle experience by checking push information, thereby exploring more strategic possibilities. In addition, it can also allow players to clearly feel the improvement of their current strength, and at the same time, it can increase the fun of the game by watching the interesting events of different players that happen here.

The following describes how events that have occurred in a region of the game are recorded.

For example, for a region in the game, all interaction events (hereinafter referred to as events) that have occurred in the region can be uploaded to a server (such as the cloud) for storage, and events stored in the cloud database are bound to the corresponding regions in the game, that is, the regions in which the events occur in the game are numbered, so that multiple events stored in the cloud database can be distinguished according to the places in which the events have occurred.

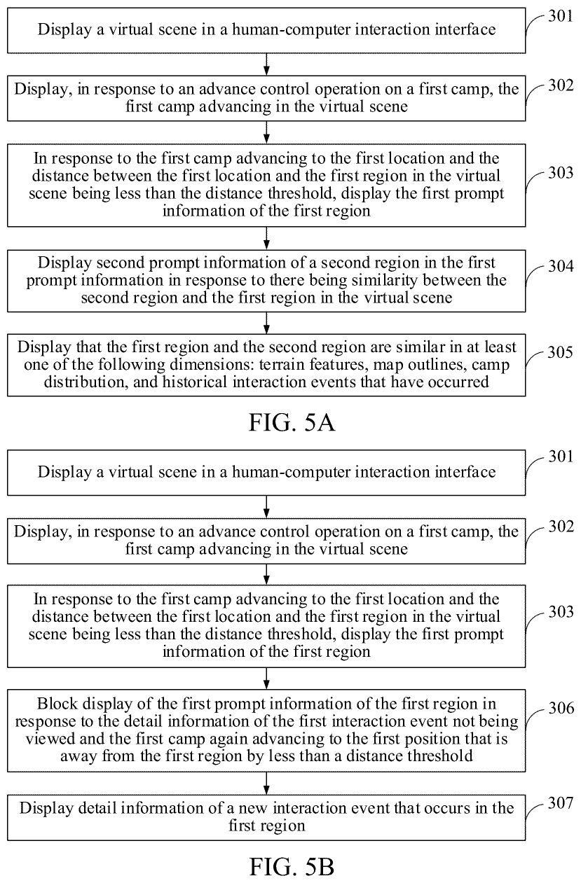

For example, FIG. 6A is a schematic flowchart of an interaction processing method for a virtual scene according to an embodiment of this application. Operations shown in FIG. 6A will be described.

Operation 601A: A client obtains information of an event that has occurred in a region.

For example, taking region 1 in the game as an example, the client can obtain information (for example, including states of the events and player operation instructions) of all events that have occurred in the region 1 (such as all events that have occurred in the past month).

Operation 602A: The client uploads the information to the cloud and numbers the information.

For example, still taking region 1 in the game as an example, after the client obtains information of all events that have occurred in region 1, the client can send the obtained information to a server (such as the cloud) for storage in a cloud database. At the same time, the cloud server can also number the region 1 in the game. For example, assuming that the serial number corresponding to the region 1 is “1”, the events that have occurred in region 1 can be bound to the serial number “1”.

In other embodiments, for a region in the game, only classic battles that have occurred in this region (such as events whose durations exceed a duration threshold) can be uploaded to the cloud for storage.

For example, FIG. 6B is a schematic flowchart of an interaction processing method for a virtual scene according to an embodiment of this application. Operations shown in FIG. 6B will be described.

Operation 601B: A client obtains information of an event that has occurred in a region.

For example, taking the region 1 in the game as an example, the client can obtain information (for example, including states of the events and player operation instructions) of all events that have occurred in the region 1 (such as all events that have occurred in the past month).

Operation 602B: The client determines whether a duration of the event exceeds X minutes, and if not, performs operation 603B and operation 604B, and if yes, performs operation 605B and operation 606B.

For example, after obtaining all events that have occurred in the region 1, the client can also perform the following processing for each event: determining whether the duration of the event exceeds X minutes, where the value of X can be configured by the planner, for example, can be 5 or 10.

Operation 603B: The client determines the event as a non-classic battle.

Operation 604B: The client deletes information of the event.

For example, for an event that lasts no longer than X minutes, the client can determine the event as a non-classic battle, and can also delete information of the event.

Operation 605B: The client determines the event as a classic battle.

Operation 606B: The client uploads the information of the event to the cloud and numbers the information.

For example, for an event that lasts more than X minutes, the client can determine the event as a classic battle, and can also upload information of the event to the cloud for storage. At the same time, the cloud server can also number the place (for example, the region 1) in which the event occurred in the game, thereby binding the event stored in the cloud database to the corresponding region in the game.

For example, when the player controls the team to march on the map of the SLG game and pass through some regions, big data information push is triggered. The push information may be historical battle events that the player participates in, or historical battle events that other players followed by the player participate in, or historical battle events accurately pushed based on big data, for example, famous scenes that have occurred for other players in the region and that are pushed by analyzing player game behavior preferences (such as a battle event whose duration exceeds the duration threshold).

For example, refer to FIG. 4A. FIG. 4A is a schematic diagram of an interaction processing method for a virtual scene according to an embodiment of the present application. As shown in FIG. 4A, when the player controls a first camp 401 to reach a first location whose distance from a first region 402 is less than a distance threshold, first prompt information 403 of the first region can be displayed, such as “you have a memory here”. The first prompt information 403 is carried in an information display control 404, and the information display control 404 includes a detail entrance 405 and a closing entrance 406. When a click operation on the detail entrance 405 is received, a pop-up window 407 is displayed, and a video 408 for introducing the historical battle is displayed in the pop-up window 407. When a click operation on the closing entrance 406 is received, the display of the information display control 404 may be cancelled.

For example, the server can also pre-establish a game historical behavior database, such as collect historical battle events of all players in the game, upload the historical battle event information to the cloud database and number the information. Then, when some player character behaviors trigger a serial number corresponding to a region, the information of historical battle events bound to the region and stored in the cloud database can be pushed to the player.

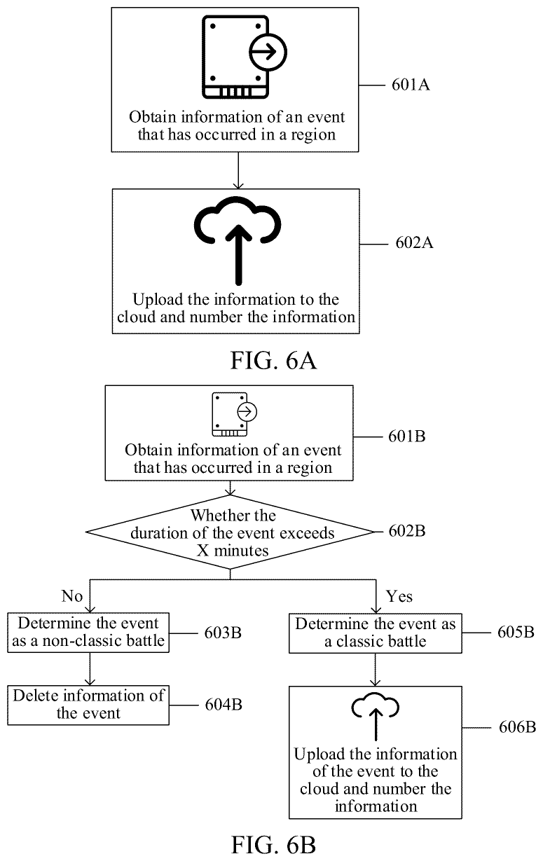

For example, FIG. 7 is a schematic flowchart of an interaction processing method for a virtual scene according to an embodiment of this application. Operations shown in FIG. 7 will be described.

Operation 701: A client obtains information of an event that has occurred in a region.

For example, for each region in which an event has occurred in the game, the client can obtain information of the event that has occurred in the region.

Operation 702: The client uploads the information of the event to the cloud and numbers the information.

For example, for each region in which an event has occurred in the game, the client can only upload information of some events that have occurred in the region and lasted longer than the duration threshold to the cloud for storage, and number each region in which an event has occurred in the game (that is, a place in which an event occurs). For example, assuming that there are always 10 regions in which events have occurred in the game: a region 1 to a region 10, these 10 regions can be numbered, for example, assuming that the serial numbers corresponding to these 10 regions are 1 to 10, that is, the region 1 corresponds to the serial number “1”, the region 2 corresponds to the serial number “2”, and by analogy, the region 10 corresponds to the serial number “10”.

Operation 703: The client sends, to the cloud, a serial number of a region through which the team commanded by the player passes.

For example, when the client detects that the player commands the team to march and pass through the region 1 in the map (for example, the client detects that the distance between the team commanded by the player and the region 1 is less than the distance threshold), the client sends the serial number of the region 1 to the cloud server.

Operation 704: The cloud sends information of an event that has occurred in the region corresponding to the serial number to the client.

For example, in the above example, after receiving the serial number of the region 1 sent by the client, the cloud server can query information of the event bound to the serial number of the region 1 from the database based on the serial number of the region 1 (that is, the event that has occurred in the region 1 and uploaded in operation 702), and return the information of the event obtained through the query to the client of the player, so that the information can be displayed in the human-computer interaction interface of the client.

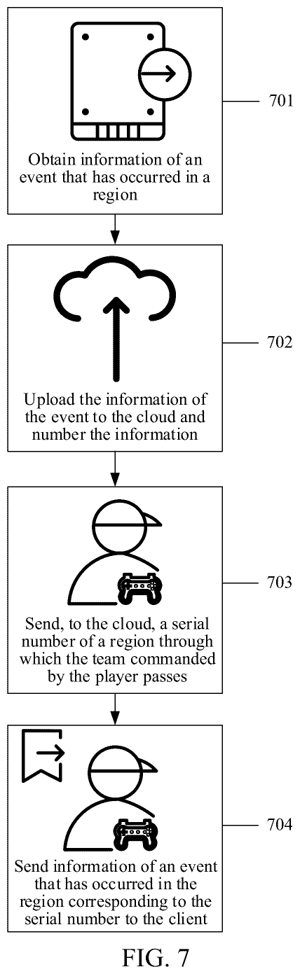

In some other embodiments, FIG. 8 is a schematic flowchart of an interaction processing method for a virtual scene according to an embodiment of this application. Operations shown in FIG. 8 will be described.

Operation 801: A server establishes a player game behavior database.

For example, the server can obtain player historical operation information and player preferred behavior information, and establish a player game behavior database based on the historical operation information and the preferred behavior information, where the preferred behavior information includes: player browsing information preferences, game behavior habits, strategies frequently used by players, a stay place of a team commanded by a player in the map, and a type of information followed by a player.

Operation 802: The server analyzes a player game behavior.

Operation 803: The server obtains a player interest behavior tag based on an analysis result.

For example, the server can collect player historical operation information, and extract player interest behavior tags from the historical operation information. For example, the server can analyze player browsing information, behavioral habits, frequently used strategies, stay places, and a type of information followed by the player, so that multiple interest behavior tags of the player (abbreviated as tags below) are obtained correspondingly.

Operation 804: The server integrates the multiple tags to obtain a tag set of the player that can be pushed.

Operation 805: The server generates a push sorting table.

For example, after obtaining the player interest behavior tag, the server can assign corresponding pushable tags and non-pushable tags to multiple events stored in the cloud database. For example, assuming that a player likes to battle with the enemy camp, the player has a “like battling” interest tag, and the battle-related events stored in the cloud database can be assigned with corresponding pushable tags (that is, it indicates that these events are events that the player is interested in), and other types of events are assigned with the non-pushable tag (that is, it indicates that these events are events that the player is not interested in). The server can then select multiple events assigned with the pushable tags from the cloud database, that is, establish a push sorting table based on the multiple selected events.

Operation 806: The server analyzes to obtain an effective pushing point.

For example, the server can analyze to obtain an effective push time period (for example, the time period in which the player commands the team to stay in the region, or the set time period before and after the player commands the team to pass through the region, for example, 10 seconds before and after the passing through) and region based on the player historical operation information stored in the database, and push the information to players according to the push sorting table in the effective time period.

In some other embodiments, fixed trigger regions (such as high-frequency player operation or battle regions) can be set in the map of the SLG game, and the events stored in the cloud database are bound to the corresponding regions in the game, that is, the place in which the event occurs is numbered. For example, for a region X, an accurate push condition of the player is Y Then, when the player commands the team to pass through the region X, the server can read battle events or other interesting events that have occurred in the region X from the cloud database, lock the content in the database based on the push condition Y of the player, and finally push the information of events that satisfies both the region X and the push condition Y to the player.

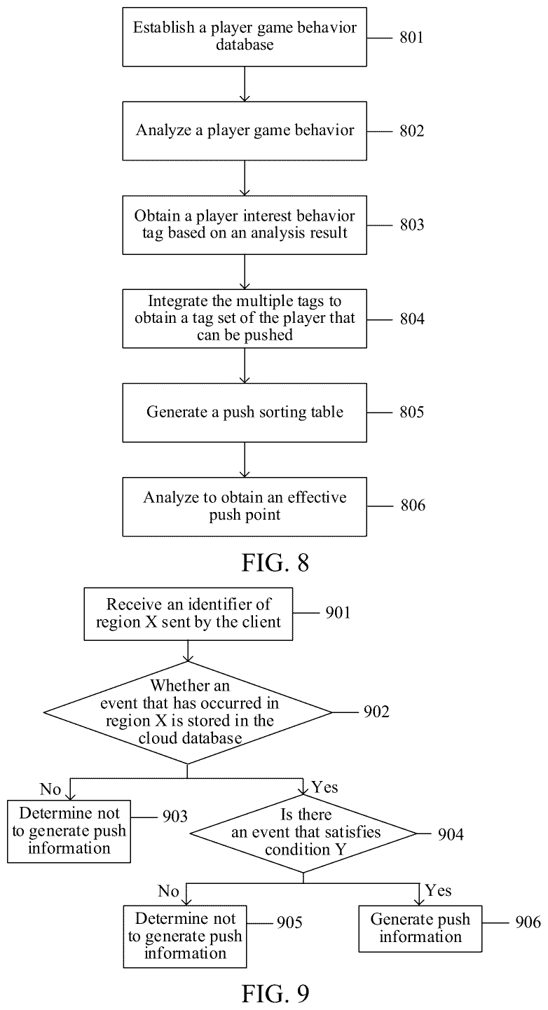

For example, FIG. 9 is a schematic flowchart of an interaction processing method for a virtual scene according to an embodiment of this application. Operations shown in FIG. 9 will be described.

Operation 901: The server receives an identifier of the region X sent by the client.

For example, when the client detects that the player commands the team to pass through the region X, the client can send the identifier of the region X to the server, so that the server can query the cloud database based on the identifier of the region X

Operation 902: The server determines whether an event that has occurred in the region X is stored in the cloud database; if not, performs operation 903, and if yes, performs operation 904.

Operation 903: The server determines not to generate push information.

For example, when the server does not obtain, through the query from the cloud database based on the identifier of the region X, battle events or other interesting events that have occurred in the region X, it is determined not to generate push information.

Operation 904: The server determines whether there is an event that satisfies the condition Y; if not, performs operation 905, and if yes, performs operation 906.

Operation 905: The server determines not to generate push information.

Operation 906: The server generates push information.

For example, when the server obtains, through the query from the cloud database based on the identifier of region X, battle events or other interesting events that have occurred in the region X, it can be further determined whether the event obtained through query satisfies the push condition Y of the player, for example, it can be determined whether the type of the event obtained through query matches the player interest behavior tag. If not, the server determines not to generate push information. If yes, the server can generate push information, to push events that satisfy both the region X and the push condition Y to the player.

The interaction processing method for a virtual scene provided by the present disclosure can be applied in the march of the map of the SLG game. When the player controls the team to march and pass through some regions, historical battle events that have occurred in the region can be triggered, to obtain more interesting information, enrich interaction methods in the game, avoid the game being streamlined and lack of more interesting exploration, and effectively improve player activity, player stickiness, and player game experience.

The following continues to describe a structure of an interaction processing apparatus 555 for a virtual scene implemented as software modules provided by aspects of the present application. For example, as shown in FIG. 2, the software modules of the interaction processing apparatus 555 for a virtual scene stored in a memory 550 can include: a display module 5551.

The display module 5551 is configured to display a virtual scene in a human-computer interaction interface, the virtual scene including multiple camps, and each of the camps including at least one virtual object. The display module 5551 is further configured to display, in response to an advance control operation on a first camp, the first camp advancing in the virtual scene. The display module 5551 is further configured to display first prompt information of a first region in response to the first camp advancing to a first location and a distance between the first location and the first region in the virtual scene being less than a distance threshold, the first prompt information representing that a first interaction event between the multiple camps has occurred in the first region.

For example, a type of the first interaction event includes at least one of the following: an interaction event in which a first account participates, an interaction event in which a second account that has a social relationship with the first account participates, and an interaction event in which any account participates and that reaches a popularity threshold; where the first account is configured for logging in to the human-computer interaction interface to control the first camp.

For example, the first prompt information is carried in an information display control, and the information display control includes a detail entrance and a closing entrance; and the display module 5551 is further configured to display detail information of the first interaction event in response to a triggering operation on the detail entrance; and the interaction processing apparatus 555 for a virtual scene further includes a stop module 5552, configured to stop displaying the first prompt information in response to a triggering operation on the closing entrance.

For example, the display module 5551 is further configured to: in response to the first camp advancing to the first location and the distance between the first location and the first region in the virtual scene being less than the distance threshold, display the first prompt information of the first region in at least one of the following time periods: a first time period of advancing from the first location to reach the boundary of the first region; a second time period spent in the first region; and a third time period of leaving the first region and advancing to a second location.

For example, when displaying the first prompt information of the first region, the display module 5551 is further configured to perform one of the following processing: switching, according to a region sorting manner, to display prompt information of a next region of the first region in response to the detail information of the first interaction event not being viewed; or switching, according to a region sorting manner, to display prompt information of a next region of the first region in response to the detail information of the first interaction event being viewed and a display duration of the detail information of the first interaction event reaching a display duration threshold.

For example, the region sorting manner includes: distances between the multiple regions and the first camp are in ascending order; and scores corresponding to the multiple regions are in descending order, where the score of each region is determined based on at least one of the following information about the region: whether the first camp has reached the region, similarity between a characteristic of an interaction event that has occurred in the region and a characteristic of the first account, and scale of the interaction event that has occurred in the region; where the first account is configured for logging in to the human-computer interaction interface to control the first camp.

For example, when displaying the first prompt information of the first region, the display module 5551 is further configured to perform the following processing: displaying prompt information respectively corresponding to multiple regions located on at least one side of an advance route of the first camp; or displaying prompt information respectively corresponding to multiple regions within the field of view of the first camp.

For example, the interaction processing apparatus 555 for a virtual scene further includes a determining module 5553 and a sorting module 5554. The determining module 5553 is configured to determine scores of the multiple regions when the number of multiple regions is greater than a number threshold. The sorting module 5554 is configured to perform descending sorting according to the scores of the multiple regions to obtain a descending sorting result. The display module 5551 is further configured to display prompt information respectively corresponding to a first number of regions starting from the first place in the descending sorting result, to replace display of the prompt information respectively corresponding to the multiple regions, where the first number is smaller than the total number of the multiple regions. The determining module 5553 is further configured to determine the score of each region in the following manner: performing quantitative processing on whether the first camp has reached the region, the similarity between the characteristic of the interaction event that has occurred in the region and the characteristic of the first account, and the scale of the interaction event that has occurred in the region, to correspondingly obtain multiple quantitative values, where the first account is configured for logging in to the human-computer interaction interface to control the first camp; and performing weighted summation processing on the multiple quantitative values, and determining an obtained weighted summation result as the score of the region.

For example, the determining module 5553 is further configured to determine the scores of the multiple regions when the number of the multiple regions is greater than the number threshold. The sorting module 5554 is further configured to perform descending sorting according to the scores of the multiple regions to obtain a descending sorting result. The display module 5551 is further configured to display prompt information respectively corresponding to a first number of regions starting from the first place in the descending sorting result, to replace display of the prompt information respectively corresponding to the multiple regions, where the first number is smaller than the total number of the multiple regions. The determining module 5553 is further configured to determine the score of each region in the following manner: calling, based on information of the region, a machine learning model for prediction processing to obtain the score of the region, where the machine learning model is trained based on multiple sample regions, initial scores of the multiple sample regions are calculated based on a rule, for a sample region that is subsequently viewed among the multiple sample regions, a score of the sample region that is viewed is increased, for a sample region that is subsequently not viewed among the multiple sample regions, a score of the sample region that is not viewed is reduced, and the multiple sample regions with updated scores are used as new sample regions to iteratively train the machine learning model.

For example, when different types of first interaction events have occurred in the first region, the display module 5551 is further configured to display detail entrances respectively corresponding to the different types of first interaction events in the first prompt information; and is configured to display detail information of the first interaction event of any type in response to a triggering operation on a detail entrance corresponding to the first interaction event of the type.

For example, when different types of first interaction events have occurred in the first region, the display module 5551 is further configured to: in response to a triggering operation on the first prompt information, display the detail entrances respectively corresponding to the different types of first interaction events; and is configured to display detail information of the first interaction event of any type in response to a triggering operation on a detail entrance corresponding to the first interaction event of the type.

For example, when displaying the first prompt information of the first region, the display module 5551 is further configured to perform the following processing: displaying the detail information of the first interaction event in response to a number of the first interaction events that have occurred in the first region being less than a number threshold and the first camp not currently interacting with another camp, to replace display of the first prompt information, where the detail information is used to introduce the first interaction event; and the stop module 5552 is further configured to stop displaying the detail information of the first interaction event in response to a closing operation on the detail information of the first interaction event or the display duration of the detail information of the first interaction event reaching a display duration threshold.

For example, the display module 5551 is further configured to display second prompt information of a second region in the first prompt information in response to there being similarity between the second region and the first region in the virtual scene, where the second prompt information represents that a second interaction event between the multiple camps has occurred in the second region, and display that there is similarity between the first region and the second region in at least one of the following dimensions: terrain features, map outlines, camp distribution, and historical interaction events that have occurred.

For example, the display module 5551 is further configured to display a push setting control of the first prompt information in the human-computer interaction interface, where the push setting control includes at least one of the following: a region setting control, configure for setting an introduction-allowed region and an introduction-forbidden region in the virtual scene, where an interaction event occurring in the introduction-allowed region can be introduced through corresponding introduction information, and an interaction event occurring in the introduction-forbidden region cannot be introduced through corresponding introduction information; a data format setting control, configure for setting a data format that is allowed to be pushed, where the data format includes at least one of the following: a video, an image, and a text; an event type setting control, configure for setting an event type that is allowed to be pushed, where the event type includes at least one of the following: an interaction event in which a first account participates, an interaction event in which a second account that has a social relationship with the first account participates, and an interaction event that reaches a popularity threshold, where the first account is configured for logging in to the human-computer interaction interface to control the first camp; and a time period setting control, configured for setting a time period during which push is allowed or forbidden.

For example, the interaction processing apparatus 555 for a virtual scene further includes a blocking module 5555, configured to block display of the first prompt information of the first region in response to the detail information of the first interaction event not being viewed and the first camp again advancing to the first location whose distance from the first region is less than a distance threshold; and the display module 5551 is further configured to display detail information of a new interaction event that has occurred in the first region, where the new interaction event occurs in a time period in which the first camp left the first region.

For example, the interaction processing apparatus 555 for a virtual scene further includes a matching module 5556 and a switching module 5557. The matching module 5556 is configured to: before the display module 5551 displays the first prompt information of the first region, match the characteristic of the first interaction event with a tag set of the first account, where the first account is configured for logging in to the human-computer interaction interface to control at least one virtual object included in the first camp. The switching module 5557 is configured to switch to perform processing of displaying the first prompt information of the first region in response to a tag in the tag set matching the characteristic of the first interaction event; and the blocking module 5555 is further configured to block display of the first prompt information of the first region in response to no tag in the tag set matching the characteristic of the first interaction event.

For example, when there are multiple first interaction events and tags in the tag set respectively match characteristics of a second number of first interaction events, the sorting module 5554 is further configured to sort the second number of first interaction events to obtain a sorting result, where the second number is less than or equal to the total number of the multiple first interaction events, and a sorting manner includes: a descending order of scales of the second number of first interaction events, and an ascending order of differences between occurrence times of the second number of first interaction events and a current time, where the sorting result is configured for indicating display priorities of detail information of the second number of first interaction events.

For example, the determining module 5553 is further configured to determine the tag set of the first account in the following manner: obtaining information of multiple dimensions of the first account, where the information of multiple dimensions includes: browsing information, a behavioral habit, a strategy whose usage frequency reaches a frequency threshold in the virtual scene, a region in which a duration of controlling the first camp to stay reaches a duration threshold, and a type of information followed by the first account; performing tag extraction processing on the information of the multiple dimensions respectively, to obtain multiple tags correspondingly; and performing deduplication processing on the multiple tags to obtain the tag set of the first account.

For example, each region in which an interaction event has occurred in the virtual scene has a corresponding identifier; and the interaction processing apparatus 555 for a virtual scene further includes a query module 5558, configured to: after receiving a trigger operation on the first prompt information, query, based on an identifier of the first region, detail information of the first interaction event that has occurred in the first region from a database, where the database pre-stores an identifier corresponding to each of the regions in the virtual scene and detail information of the interaction event that has occurred in each of the regions.

The foregoing descriptions of this disclosure are similar to the foregoing descriptions and can have beneficial effects. Example implementations can be understood based on the description of any one of FIG. 3, FIG. 5A, or FIG. 5B.

The present disclosure provides a computer program product, including a computer program or computer executable instructions stored in a computer-readable storage medium. A processor of a computer device reads the computer executable instructions from the computer-readable storage medium, and the processor executes the computer executable instructions, so that the computer device performs the interaction processing method for a virtual scene provided in the embodiments of the present application.

The present disclosure provides a computer-readable storage medium, such as a non-transitory computer-readable storage medium, storing computer executable instructions, where the computer executable instructions are stored. When the computer executable instructions are executed by a processor, the processor is caused to execute the interaction processing method for a virtual scene provided in the embodiments of the present application, for example, the interaction processing method for a virtual scene shown in FIG. 3, FIG. 5A, or FIG. 5B.

For example, the computer-readable storage medium may be a memory such as an FRAM, a ROM, a PROM, an EPROM, an EEPROM, a flash memory, a magnetic surface memory, an optical disc, or a CD-ROM; or may be various devices including one of or any combination of the foregoing memories.

For example, the executable instruction may be in the form of programs, software, software modules, scripts, or code written in any form of programming language (including compiled or interpreted languages, or declarative or procedural languages), and can be deployed in any form, for example, deployed as a stand-alone program or as a module, component, subroutine, or other units suitable for usage in a computing environment.

As an example, the executable instruction can be deployed to be executed on one electronic device, or on multiple electronic devices located at one site, or on multiple electronic devices distributed across multiple sites and interconnected by a communication network.

The foregoing descriptions are merely examples of aspects of the present disclosure and are not intended to limit the protection scope of this application. The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive. Any modification, equivalent replacement, or improvement made without departing from the spirit and scope of this disclosure shall fall within the protection scope of this application.

What is claimed is:

1. An interaction processing method for a virtual scene, the method comprises:
displaying, by processing of an electronic device, a virtual scene in an interaction interface, the virtual scene including multiple groups, and each of the groups including at least one virtual object;
displaying, based on an advance control operation on a first group, the first group advancing in the virtual scene; and
displaying first prompt information of a first region based on the first group advancing to a first location and a distance between the first location and the first region in the virtual scene being less than a distance threshold, the first prompt information indicating that a first interaction event between the multiple groups has occurred in the first region.

2. The method according to claim 1, wherein the first interaction event comprises:
a first account that is configured to log in to the interaction interface to control the first group, a second account that has a social relationship with the first account, or a third account that reaches a popularity threshold.

3. The method according to claim 1, further comprising:
displaying detail information of the first interaction event based on an operation on a detail command; and
not displaying the first prompt information based on an operation on a close command.

4. The method according to claim 1, wherein the displaying first prompt information further comprises:
displaying the first prompt information of the first region in at least one of:
a first time period of moving from the first location to a boundary of the first region;
a second time period of staying in the first region; or
a third time period of leaving from the first region to a second location.

5. The method according to claim 1, wherein when the first prompt information of the first region is displayed, the method further comprises:
displaying, according to a region sorting manner, the first display prompt information of a next region of the first region based on a detail information of the first interaction event not being viewed; or
displaying, according to a region sorting manner, the first display prompt information of a next region of the first region based on a detail information of the first interaction event being viewed and the detail information of the first interaction event reaching a display duration threshold.

6. The method according to claim 5, wherein the region sorting manner comprises:
sorting distances between the multiple regions and the first group are in ascending order; and
sorting scores corresponding to the multiple regions in descending order, wherein the score of each region is determined based on: whether the first group has reached the region, similarity between a characteristic of an interaction event that has occurred in the region and a characteristic of an account controlling the first group, or scale of the interaction event that has occurred in the region.

7. The method according to claim 1, wherein when the first prompt information of the first region is displayed, the method further comprises:
displaying prompt information corresponding to multiple regions located on at least one side of an advance route of the first group; or
displaying prompt information corresponding to multiple regions viewing the first group.

8. The method according to claim 1, further comprising:
based on an operation on the first prompt information, displaying detail information corresponding to the first interaction event of different types.

9. The method according to claim 1, wherein when the first prompt information of the first region is displayed, the method further comprises:
displaying detail information of the first interaction event based on a number of the first interaction events that have occurred in the first region being less than a threshold and the first group not currently interacting with another group; and
stopping displaying the detail information of the first interaction event based on a close operation on the detail information or a display duration of the detail information reaching a display duration threshold.

10. The method according to claim 1, further comprising:
displaying second prompt information of a second region based on a similarity between the second region and the first region in the virtual scene, wherein the similarity between the first region and the second region includes at least one of terrain features, map outlines, group distribution, and historical interaction events that have occurred.

11. The method according to claim 1, further comprising:
displaying detail information of a new interaction event that has occurred in the first region, wherein the new interaction event occurs since the first group left the first region.

12. The method according to claim 1, further comprising:
querying, based on an identifier of the first region, detail information of the first interaction event that has occurred in the first region from a database, wherein the database includes detail information of the interaction event that has occurred in each of the regions.

13. An interaction processing apparatus for a virtual scene, the apparatus comprising:
processing circuitry configured to:
display a virtual scene in an interaction interface, the virtual scene including multiple groups, and each of the groups including at least one virtual object;
display, based on an advance control operation on a first group, the first group advancing in the virtual scene; and
display first prompt information of a first region based on the first group advancing to a first location and a distance between the first location and the first region in the virtual scene being less than a distance threshold, the first prompt information indicating that a first interaction event between the multiple groups has occurred in the first region.

14. The apparatus according to claim 13, wherein the processing circuitry is configured to:
log in to the interaction interface to control the first group by a first account, a second account that has a social relationship with the first account, or a third account that reaches a popularity threshold.

15. The apparatus according to claim 13, wherein the processing circuitry is configured to:
display detail information of the first interaction event based on an operation on a detail command; and
not display the first prompt information based on an operation on a close command.

16. The apparatus according to claim 13, wherein the processing circuitry is configured to display the first prompt information in at least one of:
a first time period of moving from the first location to a boundary of the first region;
a second time period of staying in the first region; or
a third time period of leaving from the first region to a second location.

17. A non-transitory computer-readable storage medium, storing instructions which when executed by a processor cause the processor to perform:
displaying a virtual scene in an interaction interface, the virtual scene including multiple groups, and each of the groups including at least one virtual object;
displaying, based on an advance control operation on a first group, the first group advancing in the virtual scene; and
displaying first prompt information of a first region based on the first group advancing to a first location and a distance between the first location and the first region in the virtual scene being less than a distance threshold, the first prompt information indicating that a first interaction event between the multiple groups has occurred in the first region.

18. The non-transitory computer-readable storage medium according to claim 17, wherein the instructions when executed by the processor further cause the processor to perform:
logging in to the interaction interface to control the first group by a first account, a second account that has a social relationship with the first account, or a third account that reaches a popularity threshold.

19. The non-transitory computer-readable storage medium according to claim 17, wherein the instructions when executed by the processor further cause the processor to perform:
displaying detail information of the first interaction event based on an operation on a detail command; and
not displaying the first prompt information based on an operation on a close command.

20. The non-transitory computer-readable storage medium according to claim 17, wherein the instructions when executed by the processor further cause the processor to output the first prompt information for display in at least one of:
a first time period of moving from the first location to a boundary of the first region;
a second time period of staying in the first region; or
a third time period of leaving from the first region to a second location.
